(19) United States
(12) Patent Application Publication
(10) Pub. No.: US 2026/0141438 A1
(43) Pub. Date: May 21, 2026

(54) Gift Preference Evaluation Technique

(71) Applicant: Adriana Ferreyr, Palm Beach, FL (US)

(72) Inventor: Adriana Ferreyr, Palm Beach, FL (US)

(21) Appl. No.: 19/390,441

(22) Filed: Nov. 14, 2025

Related U.S. Application Data
(60) Provisional application No. 63/721,479, filed on Nov. 16, 2024.
(60) Provisional application No. 63/721,477, filed on Nov. 16, 2024.

(51) Int. Cl. G06Q 30/0601

(52) U.S. Cl. CPC G06Q 30/06315

(57) ABSTRACT

During operation, a computer system may receive, from an electronic device, information specifying a potential gift for a recipient (such as a link to the potential gift) and second information specifying the recipient (such as a name, an email address, a phone number, etc.). In response, the computer system may access (or receive), e.g., in memory in the computer system, predefined preferences associated with the recipient. Then, the computer system may determine suitability of the potential gift for the recipient based at least in part on the predefined preferences. When the potential gift is unsuitable, the computer system may provide, addressed to the electronic device, a recommendation for a suitable alternative gift for the recipient based at least in part on the predefined preferences. Alternatively, when the potential gift is suitable, the computer system may provide, addressed to the electronic device, a confirmation to proceed with the gift.

### CROSS REFERENCE TO RELATED APPLICATIONS

This application claims priority under 35 U.S.C. 119(e) to: U.S. Provisional Application Ser. No. 63/721,479, entitled “Gift Preference Evaluation System and Related Methods,” by Adriana Ferreyr, et al., filed on Nov. 16, 2024; and U.S. Provisional Application Ser. No. 63/721,477, entitled “System and Method for Virtual Gift Sending and Related Methods,” by Adriana Ferreyr, et al., filed on Nov. 16, 2024, the contents of both of which are herein incorporated by reference.

### FIELD

The disclosed embodiments related to evaluating a potential gift for a recipient based at least in part on predefined gift preferences of the recipient.

### BACKGROUND

In today's fast-paced world, gift-giving has become an integral part of social interactions, celebrations, and expressions of appreciation. However, selecting an appropriate gift for a recipient is often a daunting task. Traditional methods of gift selection often involve guesswork or direct inquiries, which can diminish the element of surprise and personal touch. Moreover, the increasing diversity in personal tastes and the vast array of available products make it challenging for gift givers to confidently choose a gift that will be cherished by a recipient.

Moreover, the advent of digital platforms and applications has transformed various aspects of daily life, including the way people shop and give gifts. However, in spite of these advancements, there remains a significant gap in the market for tools that can assist individuals in selecting gifts that will be suitable for a recipient without compromising the element of surprise. In the absence of a more sophisticated, user-friendly solution, the overall gift giving experience often is suboptimal and frustrating to gift givers and recipients.

### SUMMARY

In a first group of embodiments, a computer system that evaluates a potential gift is described. This computer system includes: an interface circuit that communicates with an electronic device, a processor that executes program instructions, and memory that stores the program instructions. When the processor executes the program instructions, the computer system performs operations. Notably, during operation, the computer system receives, using the interface circuit and from the electronic device, information specifying the potential gift for a recipient (such as a link to the potential gift or an image of the link) and second information specifying the recipient (such as a name, an email address, a phone number, etc.). In response, the computer system accesses (or receives), e.g., in the memory, predefined preferences associated with the recipient. Then, the computer system determines suitability of the potential gift for the recipient based at least in part on the predefined preferences. When the potential gift is unsuitable, the computer system provides, addressed to the electronic device, a recommendation for a suitable alternative gift for the recipient based at least in part on the predefined preferences. Alternatively, when the potential gift is suitable, the computer system provides, addressed to the electronic device, a confirmation to proceed with the gift. (More generally, the computer system provides, addressed to the electronic device, feedback about whether or not the recipient will like the potential gift.)

Note that the predefined preferences may include abstracted information that is different from a specific product, a type of product, or wish list or a registry of gifts. For example, the predefined preferences may include: one or more characteristics of the specific product or the type of product, a preference of the recipient, or a medical constraint of the recipient.

Moreover, the suitability may be determined based on a comparison of a weighted summation of numerical values for the predefined preferences for the potential gift with a predefined threshold. Alternatively, the suitability may be determined using a pretrained neural network, such as a large language model (LLM).

Furthermore, the suitability may be determined based at least in part on additional constraints, where the additional constraints include one or more of: dietary constraints of the recipient, a clothing size of the recipient, a favorite color of the recipient, a budget, a relationship between the recipient and a planned purchaser of the potential gift, a gifting occasion, an age of the recipient, or a physical location.

Additionally, the electronic device may be associated with the planned purchaser.

In some embodiments, the predefined preferences were voluntarily defined or provided by the recipient.

Note that the recipient may have previously provided the preference, e.g., based at least in part by answering a set of questions. The predefined preferences stored in the memory may be stored in a gift preference profile of the recipient. These predefined preferences may be kept secure or private by the computer system.

Moreover, when the potential gift is suitable, the computer system may purchase the potential gift for the recipient.

Furthermore, the evaluating of the potential gift may be performed anonymously by the computer system.

Additionally, when the predefined preferences do not exist or are unavailable, the computer system may provide an invitation to the recipient to create preferences. This invitation may be provided anonymously.

Another embodiment provides a computer-readable storage medium with program instructions for use with the computer system. When executed by the computer system, the program instructions cause the computer system to perform at least some of the aforementioned operations in one or more of the preceding embodiments.

Another embodiment provides the method, which may include at least some of the aforementioned operations in one or more of the preceding embodiments.

In a second group of embodiments, a computer system that provides an indication of a gift for a recipient is described. This computer system includes: an interface circuit that communicates with an electronic device, a processor that executes program instructions, and memory that stores the program instructions. When the processor executes the program instructions, the computer system performs operations. Notably, during operation, the computer system receives information specifying the gift for the recipient. Then, when a physical address of the recipient is unknown, the computer system provides, addressed to the electronic device, the indication, where the indication includes an image of the gift.

In some embodiments, the receiving of the information may involve: receiving recipient information, including demographic data, a relationship with a giver of the gift, and/or interests of the recipient; determining a list of one or more potential gifts for the recipient; and receiving a selection of the gift from the one or more potential gifts.

Note that the indication may include a virtual representation of the gift and/or a virtual gift card. The virtual gift card may include visual elements and a personalized message and may provide an interactive experience. For example, the visual elements may include: a closed gift box, the image of the gift, confetti, and/or a message. Moreover, the indication may include a cost of the gift (which may include a price of the gift, taxes, and/or shipping costs).

Furthermore, the indication may include instructions for a recipient to use a monetary value associated with the gift. The instructions may guide the recipient on how to purchase the gift or, when the gift is not purchased, how to retain the monetary value.

Additionally, the indication may be provided using text or email.

Another embodiment provides a computer-readable storage medium with program instructions for use with the computer system. When executed by the computer system, the program instructions cause the computer system to perform at least some of the aforementioned operations in one or more of the preceding embodiments.

Another embodiment provides the method, which may include at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 is a block diagram illustrating an example of a communication with a computer system that evaluates a potential gift in accordance with an embodiment of the present disclosure.

FIG. 2 is a flow diagram illustrating an example of a method for evaluating a potential gift using the computer system of FIG. 1 in accordance with an embodiment of the present disclosure.

FIG. 3 is a drawing illustrating an example of communication among components in the computer system in FIG. 1 in accordance with an embodiment of the present disclosure.

FIGS. 4A and 4B are drawings illustrating examples of user interfaces in accordance with an embodiment of the present disclosure.

FIG. 5 is a flow diagram illustrating an example of a method for providing an indication of a gift for a recipient using the computer system of FIG. 1 in accordance with an embodiment of the present disclosure.

FIG. 6 is a drawing illustrating an example of communication among components in the computer system in FIG. 1 in accordance with an embodiment of the present disclosure.

FIGS. 7A and 7B are drawings illustrating examples of user interfaces in accordance with an embodiment of the present disclosure.

FIG. 8 is a block diagram illustrating an example of an electronic device of FIG. 1 in accordance with an embodiment of the present disclosure.

FIG. 9 is a block diagram illustrating an example of a data structure for use with the electronic device of FIG. 8 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system (which may include one or more computers) that evaluates a potential gift is described. During operation, the computer system may receive, from an electronic device, information specifying the potential gift for a recipient (such as a link to the potential gift) and second information specifying the recipient (such as a name, an email address, a phone number, etc.). In response, the computer system may access (or receive), e.g., in memory in the computer system, predefined preferences associated with the recipient. Then, the computer system may determine suitability of the potential gift for the recipient based at least in part on the predefined preferences. When the potential gift is unsuitable, the computer system may provide, addressed to the electronic device, a recommendation for a suitable alternative gift for the recipient based at least in part on the predefined preferences. Alternatively, when the potential gift is suitable, the computer system may provide, addressed to the electronic device, a confirmation to proceed with the gift. (More generally, the computer system may provide, addressed to the electronic device, feedback about whether or not the recipient will like the potential gift.)

By providing feedback about the suitability of the potential gift, these evaluation techniques may improve the quality of gifts, while maintaining the element of surprise for the recipient. Moreover, the evaluation techniques may reduce churn (such as purchases and returns of unsuitable gifts). Consequently, the evaluation techniques may improve the function of the computer system (and associated shopping systems), such as by: reducing processing cycles, reducing memory usage and/or reducing network bandwidth consumed. Therefore, the evaluation techniques may improve the user experience of the recipient, a potential purchaser of the potential gift and (who is sometimes referred to as a ‘potential giver’), more generally, a user of the computer system.

In the discussion that follows, an individual or a user (such as the recipient or the potential purchaser) may be a person. Also, or instead, the evaluation techniques may be used by any type of organization, such as a business (which should be understood to include for-profit corporations), non-profit corporations, groups (or cohorts) of individuals, sole proprietorships, government agencies, partnerships, etc.

Moreover, in the discussion that follows, electronic devices and/or components in a system (such as the computer system) may communicate using a wide variety of communication protocols. For example, the communication may involve wired or wireless communication. Notably, this communication may use a wired communication protocol, such as an Institute of Electrical and Electronics Engineers (IEEE) 802.3 standard (which is sometimes referred to as ‘Ethernet’) and/or another type of wired interface. Alternatively or additionally, the communication protocols may include: an Institute of Electrical and Electronics Engineers (IEEE) 802.11 standard (which is sometimes referred to as ‘Wi-Fi®,’ from the Wi-Fi Alliance of Austin, Texas), Bluetooth® (from the Bluetooth Special Interest Group of Kirkland, Washington), another type of wireless interface (such as another wireless-local-area-network interface), a cellular-telephone communication protocol (e.g., a 3G/4G/5G communication protocol, such as UMTS, LTE), other present or future developed advanced cellular communication protocol, Citizens Broadband Radio Service (CBRS), and/or another type of wireless interface or wireless communication protocol. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. In the discussion that follows, Ethernet and Wi-Fi are used as illustrative examples.

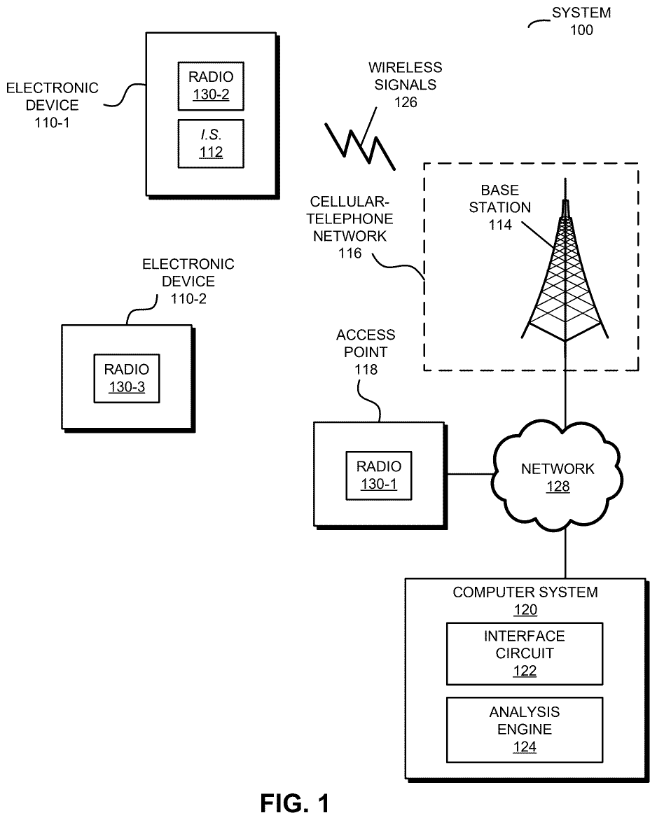

Communication among electronic devices is shown in FIG. 1, which presents a block diagram illustrating a system 100 that evaluates one or more potential gifts. Notably, system 100 includes one or more electronic devices 110 (such as portable electronic devices, e.g., cellular telephones, cameras, etc.), which may include an optional imaging sensor (I.S.) 112 (such as a CMOS image sensor, a CCD, a camera, etc.), optional base station 114 in cellular-telephone network 116, an optional access point 118 and/or a computer system 120 (such as a server), which are sometimes collectively referred to as ‘components’ in system 100. Moreover, computer system 120 may include: an interface circuit (or module) 122, and an analysis engine (or module) 124.

Note that components in system 100 may communicate with each other via cellular-telephone network 116 and/or a network 128 (such as the Internet and/or a wireless local area network or WLAN). For example, computer system 120 may receive images and/or information (such as a description of a potential gift or a link to a website or web page where the potential gift is described from electronic devices 110, and may analyze the images and/or information, e.g., using program instructions or one or more machine-learning models (such as an LLM, e.g., a version of ChatGPT from Open AI of San Francisco, California). In general, at least portions of the one or more machine-learning models may be executed by one or more of electronic devices 110, computer system 120 or both.

In addition, electronic device 110-1 may provide, via cellular-telephone network 116 and/or network 128, a result of the evaluation of the potential gifts (such as feedback about whether or not the gift is suitable for a recipient.

In embodiments where the communication involves wireless communication via a WLAN, the wireless communication includes: transmitting advertising frames on wireless channels, detecting another component in system 100 by scanning wireless channels, establishing connections (for example, by transmitting association requests, data/management frames, etc.), optionally configuring security options (e.g., Internet Protocol Security), and/or transmitting and receiving packets or frames via the connection (which may include information that specifies the potential gift, the feedback about the suitability of the potential gift, etc.). Moreover, in embodiments where the communication involves wireless communication via cellular-telephone network 116 and/or the WLAN, the wireless communication may include: establishing connections, and/or transmitting and receiving packets (which may include information that specifies the one or more machine-learning models, the measurement results, etc.).

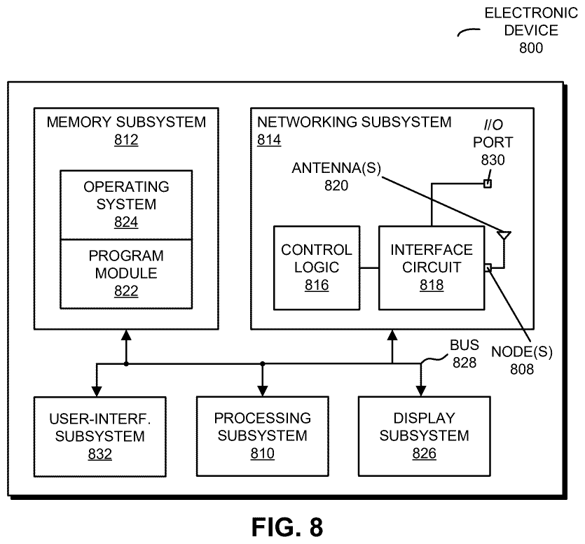

As described further below with reference to FIG. 8, electronic devices 110, optional base station 114, optional access point 118 and/or computer system 120 may include subsystems, such as a networking subsystem, a memory subsystem and a processor subsystem. In addition, electronic devices 110, optional base station 114, optional access point 118 and/or computer system 120 may include radios 130 in the networking subsystems. More generally, the components can include (or can be included within) any electronic devices with the networking subsystems that enable these components to communicate with each other.

Moreover, as can be seen in FIG. 1, wireless signals 126 (represented by jagged lines) are transmitted by radios 128 in the components. For example, radio 130-1 in optional access point 118 may transmit information (such as frames or packets) using wireless signals 126. These wireless signals may be received by radios 128 in one or more of the other components, such as by electronic device 110-1. This may allow computer system 120 and electronic device 110-1 to communicate information with each other.

In the described embodiments, processing a packet or frame in a component may include: receiving the wireless signals with the packet or frame; decoding/extracting the packet or frame from the received wireless signals to acquire the packet or frame; and processing the packet or frame to determine information contained in the packet or frame (such as the one or more machine-learning models, a potential gift, etc.).

Note that the communication between at least any two of the components in system 100 may be characterized by one or more of a variety of performance metrics, such as: a received signal strength indication (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

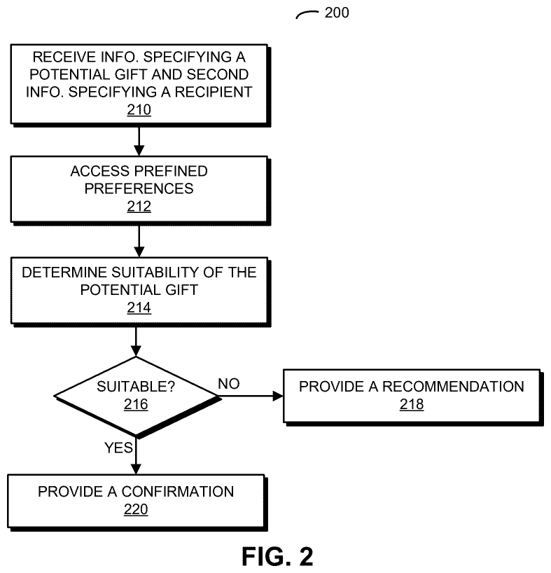

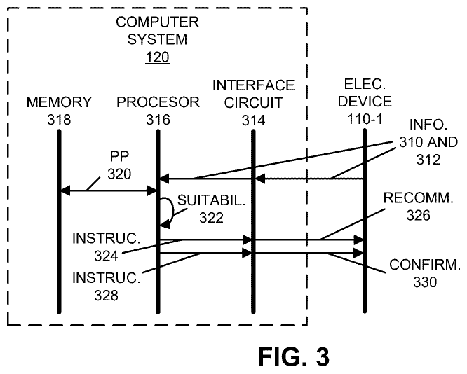

As discussed previously, it can be difficult to buy a suitable gift for a recipient. As described further below with reference to FIGS. 2 and 3, in order to address this problem, computer system 120 may be used to evaluate a potential gift for a recipient, and to provide feedback to a potential purchaser about suitability of the potential gift based at least in part on predefined preferences of the recipient and/or one or more additional constraints.

In some embodiments, the evaluation of the suitability of a potential gift may be computed by analysis module 124 by comparing a weighted summation of values of the predefined preferences for the potential gift with a predefined threshold (such as 50%). When the weighted summation exceeds the predefined threshold, the potential gift may be deemed suitable. In these embodiments, interface module 122 in computer system 120 may provide, to electronic device 110-1 (which may be used by or associated with the potential purchaser or user), a confirmation of the suitability of the gift. Then, computer system 120 may provide, to electronic device 110-1, a request to purchase the potential gift for the recipient. When the request is accepted by the user or (now) purchaser, computer system 120 may purchase the gift and may optionally ship it to the purchaser or the recipient.

However, when the weighted summation is less than the predefined threshold, the potential gift may be deemed unsuitable. In these embodiments, analysis module 124 may reject the potential gift and may interface module 122 may provide, to electronic device 110-1, a message rejecting the potential gift and optionally a recommendation for an alternative gift for the recipient. This alternative gift may be suitable, as indicated by a comparison of a weighted summation of values of the predefined preferences and the predefined threshold.

In these ways, computer system 120 (such as software or a software application executed in an environment, such as an operating system, of computer system 120) may improve the quality of gifts, while maintaining the element of surprise for the recipient. This capability may enhance the user experience when using electronic device 110-1 and/or computer system 120, and more generally when selecting and (eventually) purchasing a gift for a recipient.

While the preceding discussion illustrated analysis module 124 comparing values of the predefined preferences for the potential gift for the recipient to the predefined threshold, in other embodiments a pretrained machine-learning model (such as an LLM) that is executed by analysis module 124 (such as by one or more graphics processing units or GPUs) may be used to evaluate the suitability of the potential gift.

Note that the program instructions in analysis module 124 may include: a standalone software application or a portion of another software application that is resident on and that executes on computer system 120 and/or electronic device 110-1 (such as a software application that is provided by computer system 120 and/or electronic device 110-1, or that is installed on and that executes on computer system 120 and/or electronic device 110-1). Alternatively or additionally, at least a portion of the software application executing on computer system 120 and/or electronic device 110-1 may be an application tool that is embedded in the web page, and that executes in a virtual environment of a web browser. Thus, the application tool may be provided to a user of computer system 120 and/or electronic device 110-1 via a client-server architecture.

Although we describe the network environment shown in FIG. 1 as an example, in alternative embodiments, different numbers or types of electronic devices may be present. For example, some embodiments comprise more or fewer components. As another example, in another embodiment, different components are transmitting and/or receiving packets or frames.

We now describe embodiments of the evaluation techniques. FIG. 2 presents a flow diagram illustrating an example of a method 200 for evaluating a potential gift, which may be performed by a computer system (such as computer system 120 in FIG. 1). During operation, the computer system may receive, from an electronic device, information specifying the potential gift (operation 210) for a recipient (such as a link to the potential gift) and second information specifying the recipient (operation 210), such as a name, an email address, a phone number, etc. In response, the computer system may access, e.g., in memory, predefined preferences (operation 212) associated with the recipient. Then, the computer system may determine suitability of the potential gift (operation 214) for the recipient based at least in part on the predefined preferences. When the potential gift is unsuitable (operation 216), the computer system may provide, addressed to the electronic device, a recommendation (operation 218) for a suitable alternative gift for the recipient based at least in part on the predefined preferences. Alternatively, when the potential gift is suitable (operation 216), the computer system may provide, addressed to the electronic device, a confirmation (operation 220) to proceed with the gift. (More generally, the computer system provides, addressed to the electronic device, feedback about whether or not the recipient will like the potential gift.)

Note that the predefined preferences may include abstracted information that is different from a specific product, a type of product, or wish list or a registry of gifts. For example, the predefined preferences may include: one or more characteristics of the specific product or the type of product, a preference of the recipient, and/or a medical constraint of the recipient.

Moreover, the suitability may be determined based on a comparison of a weighted summation of numerical values for the predefined preferences for the potential gift with a predefined threshold. Alternatively, the suitability may be determined using a pretrained neural network, such as an LLM.

Furthermore, the suitability may be determined based at least in part on additional constraints, where the additional constraints include one or more of: dietary constraints of the recipient, a clothing size of the recipient, a favorite color of the recipient, a budget, a relationship between the recipient and a planned purchaser of the potential gift, a gifting occasion, an age of the recipient, and/or a physical location.

Additionally, the electronic device may be associated with the planned purchaser.

In some embodiments, the predefined preferences were voluntarily defined or provided by the recipient.

Note that the recipient may have previously provided the preference, e.g., based at least in part by answering a set of questions. The predefined preferences stored in the memory may be stored in a gift preference profile of the recipient. These predefined preferences may be kept secure or private by the computer system.

Moreover, the evaluating of the potential gift may be performed anonymously by the computer system.

In some embodiments, the computer system optionally performs one or more additional operations. For example, when the potential gift is suitable (operation 216), the computer system may purchase the potential gift for the recipient.

Furthermore, when the predefined preferences do not exist or are unavailable, the computer system may provide an invitation to the recipient to create preferences. This invitation may be provided anonymously.

In some embodiments of method 200, there may be additional or fewer operations. Moreover, the order of the operations may be changed, and/or two or more operations may be combined into a single operation.

Embodiments of the evaluation techniques are further illustrated in FIG. 3, which presents a drawing illustrating an example of communication among components in computer system 120. Notably, electronic device 110-1 may provide (e.g., in one or more packets or frames) information 310 specifying a potential gift for a recipient and information 312 specifying the recipient.

After receiving information 310 and 312, an interface circuit 314 in computer system 120 may provide information 310 and 312 to a processor 316 in computer system 120. Then, processor 316 may access, e.g., in memory 318 in computer system 120, predefined preferences (PP) 320 associated with the recipient.

Using predefined preferences 320, processor 316 may determine suitability 322 of the potential gift for the recipient. When the potential gift is unsuitable, processor 316 may instruct 324 interface circuit 314 to provide, addressed to electronic device 110-1, a recommendation 326 for a suitable alternative gift for the recipient based at least in part on predefined preferences 320. Alternatively, when the potential gift is suitable, processor 316 may instruct 328 interface circuit 314 to provide, addressed to electronic device 110-1, a confirmation 330 to proceed with the gift (such as purchasing the gift for the recipient).

While FIG. 3 illustrates communication between components using unidirectional or bidirectional communication with lines having single arrows or double arrows, in general the communication in a given operation in this figure may involve unidirectional or bidirectional communication. Moreover, while operations are presented sequentially in FIG. 3, in general at least some of the operations may be performed concurrently or in parallel.

We now further describe the evaluation techniques. These evaluation techniques may be implemented using a software application, which is henceforth referred to as a ‘GimmeGift application.’ The GimmeGift application may be accessed by the gift giver to input a gift idea for a recipient. The input of the gift idea may be facilitated by allowing the user to either write the name of the gift or paste a link to the item. Moreover, the user may select the recipient from a personal recipients list or searched for based at least in part on the recipient's full name, email address, and/or phone number. When the recipient does not have an existing gift profile (with their preferences), an invitation may be sent anonymously to the recipient's contact information (which may include their phone number or email address) to create a gift profile.

In some embodiments, the computer system may ensure that the recipient's preferences are kept private. The GimmeGift application may enable users to evaluate whether a potential gift would be appreciated by or suitable for the recipient.

The GimmeGift application may receive feedback after scanning or accessing the recipient's gift profile, which may include personal preferences stored in a data structure of gift profiles. The feedback may inform the user that the gift is suitable, allowing the user to proceed with gifting if the feedback is positive. However, when the feedback indicates that the recipient will not like the gift or that the gift is not suitable for the recipient, the user may restart the gift evaluation process and/or may receive one or more alternative gift suggestions based at least in part on: the user's budget, a relationship with the recipient (such as a spouse, a sibling, another type of relative, a co-worker, a friend, etc.), and/or the gifting occasion. The computer system may provide these suggestions to offer alternative gift ideas. In some embodiments, the gift-evaluation process may be conducted anonymously, thereby ensuring the privacy of the recipient's preferences.

Note that the gift-evaluation process may involve scanning or accessing a recipient's gift preferences, which may be stored privately in a data structure. This may be facilitated by the gift-evaluation system, which can access the recipient's predefined gift profile. The gift profile may have been created by the recipient answering questions about their personal preferences, ensuring that the preferences are kept private by the computer system. The scanning or accessing may serve to determine whether the recipient will appreciate a specific gift idea and, thus, whether the specific gift idea is suitable for the recipient. The computer system may include a data structure of gift profiles containing recipients'predefined personal preferences, which may be used to provide information for determining gift suitability. The privacy of the recipient's preferences may be ensured by the computer system, which may be an aspect of maintaining the confidentiality of the recipient's personal information. This operation may be in the overall process of anonymously evaluating the suitability of a gift for a recipient, as it may provide the necessary data to inform the user if the gift is suitable. Furthermore, the scanning or accessing the recipient's gift profile may be an operation that enables the computer system to assess the compatibility of the gift idea with the recipient's predefined preferences, thereby facilitating a more informed gifting decision.

The computer system may determine whether the recipient will like the gift based at least in part on the recipient's predefined gift preferences. This determination may involve the gift evaluation system, which may analyze the recipient's stored predefined preferences to assess the suitability of the proposed gift. The recipient's predefined preferences, which may be stored in a gift profile, can be accessed by the computer system to facilitate this evaluation. The computer system may use the information contained in the gift profile, which may include personal preferences that the recipient has previously provided. This process may be conducted anonymously, thereby ensuring that the recipient's privacy is maintained throughout the evaluation.

Then, the computer system may provide feedback to the user, indicating whether the recipient is likely to appreciate the gift or whether the gift is suitable for the recipient. This feedback may guide the user in deciding whether to proceed with the gifting process or to consider alternative options. Note that the determination may enable users to make informed decisions about potential gifts without directly consulting the recipient.

The feedback may be generated or selected by the gift evaluation system after scanning or accessing the recipient's predefined gift preferences. The feedback may be communicated to the user, potentially prompting them to proceed with gifting when the feedback indicates that the recipient will appreciate the gift. The user may then proceed with gifting, e.g., through the gift evaluation system. Alternatively, when the feedback indicates that the recipient may not like the gift, the user may restart the gift evaluation process. Additionally, the computer system may provide one or more alternative gift suggestions to the user when the feedback is negative or the gift is not suitable for the recipient. These suggestions may be based at least in part on factors such as: the user's budget, their relationship with the recipient, and/or the gifting occasion. The ability of the computer system to provide such feedback and suggestions may be facilitated by its capacity to scan or access the recipient's gift profile, which may include personal preferences stored in a data structure. This process may ensure that the user's gift idea aligns with the recipient's preferences, thereby enhancing the suitability of the gift.

In some embodiments, a user may enter a potential gift or a gift idea into the computer system. For example, the user may type a name of the gift or may paste a link to the item in a user interface. Then, the computer system may use this input to scan or access the recipient's predefined gift preferences stored in memory in a gift profile. The gift profile may include personal preferences that the recipient has previously provided, ensuring that the gift evaluation process is tailored to the recipient's tastes. Based at least in part on a suitability of the potential gift, the computer system may provide the user with feedback about whether or not the recipient will like the potential gift or the suitability of the potential gift. This feedback may be based at least in part on an analysis of the recipient's predefined preferences, which may be kept private by the computer system. The user interface may also facilitate the process of selecting a recipient from a personal recipients list or searching based at least in part on a full name, email address, and/or phone number of the recipient. This selection process may help ensure that the potential gift is checked or evaluated against the correct recipient's predefined preferences. Thus, the user interface may enable a user to anonymously evaluate the suitability of a potential gift for a recipient.

The feedback to the user regarding the suitability of a gift idea or a potential gift may occur after a comprehensive scanning of the recipient's gift profile by the computer system. The feedback may be generated based at least in part on the recipient's personal preferences stored in a data structure of gift profiles. The feedback provided by the computer system may inform the user whether or not the potential gift is suitable for the recipient, thereby allowing the gift giver to ascertain whether or not a recipient will like a specific gift idea without directly consulting the recipient. This process may involve the user inputting the name of the gift or pasting a link to the item, which the computer system then evaluates against the recipient's stored preferences. The software application may enable users to evaluate whether a potential gift would be appreciated by the recipient, thus facilitating an anonymous and informed gifting process.

In some embodiments, the gift profile may be created by the recipient answering questions about their personal preferences. These preferences may be kept private by the computer system, thereby ensuring that the recipient's information is securely managed. The computer system may access the recipient's gift profile to assess the suitability of a potential gift, thereby allowing a gift giver to find out whether or not a recipient will like a specific idea for a gift without directly consulting the recipient. The feedback provided to the user may be based at least in part on the suitability analysis, indicating whether the recipient will like the potential gift.

When a potential gift is suitable for a recipient, the computer system may prompt the user to proceed with gifting based at least in part on the feedback received. The feedback, which may be generated by the computer system, may indicate whether the recipient is likely to appreciate the gift. When the feedback is positive, the computer system may encourage the user to continue with the gifting process. This process may involve the user creating and sending the gift through the software application.

Moreover, when the feedback is negative (the potential gift is not suitable), the computer system may generate or select one or more alternative suggestions. These suggestions may be based at least in part on various factors, including: the user's budget, the relationship with the recipient, and/or the occasion for gifting. The computer system may leverage the stored predefined preferences to help ensure that the suggestions align with the recipient's tastes and preferences. Note that the computer system may ensure the privacy of the recipient's preferences while providing these suggestions.

Furthermore, the computer system may facilitate the selection or searching of recipients by the user. For example, the user to choose or to select a recipient from a personal recipients list or may search for the recipient using the recipient's full name, email address, and/or phone number. The user may interact with the computer system to input these details, which may then be processed to identify the correct recipient and, thus, the correct gift profile. Thus, these operations may determine the recipient's identity and may allow the computer system to access the recipient's predefined preferences. Thus, the identification of the recipient may allow the computer system to evaluate a potential gift in a personalized and accurate manner.

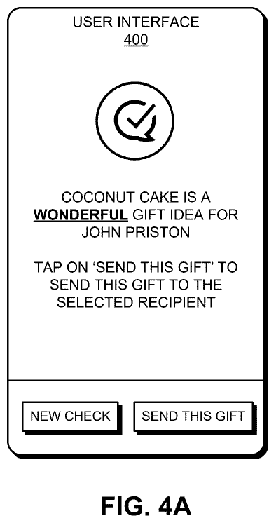

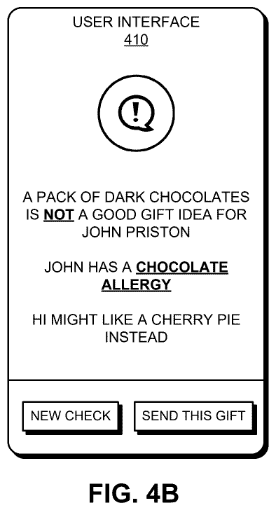

FIGS. 4A and 4B present drawings illustrating examples of user interfaces. Notably, FIG. 4A presents a user interface 400 in the evaluation techniques when a potential gift is suitable for a recipient, and FIG. 4B presents a user interface 410 in the evaluation techniques when a potential gift is unsuitable for the recipient.

We now describe embodiments of gift delivery techniques. In today's fast-paced world, the tradition of gift-giving has evolved significantly, with technology playing a pivotal role in transforming how gifts are selected, purchased, and delivered. Moreover, the rise of e-commerce platforms has made it easier for individuals to shop for gifts online, offering a wide array of options at their fingertips. However, this convenience also comes with its own set of challenges. One issue faced by gift-givers is the difficulty in selecting the perfect gift that aligns with a recipient's preferences, interests, and needs. This challenge is further compounded when the giver lacks detailed knowledge about the recipient's current interests or when the recipient's delivery address is unknown.

Furthermore, the traditional process of gift-giving often involves logistical hurdles, such as ensuring the gift is delivered on time and in good condition, which can be particularly challenging during peak holiday season. Additionally, there is a growing demand for more personalized and meaningful gifting experiences that go beyond the mere exchange of physical items. Consequently, there is a need for solutions that can streamline the gift-giving process, making it more efficient, personalized, and flexible, while also addressing the logistical challenges associated with traditional gift delivery methods. This has led to the exploration of virtual gifting solutions that leverage technology to enhance the overall gifting experience.

Referring to FIG. 1, electronic device 110-1 may provide, addressed to computer system 120, information specifying a gift for a recipient. For example, a user of electronic device 110-1 may provide a user selection of the gift for the recipient. Then, when a physical address of the recipient is unknown, computer system 120 may provide, addressed to electronic device 110-2 (which is associated with or used by the recipient), the indication, where the indication includes an image of the gift.

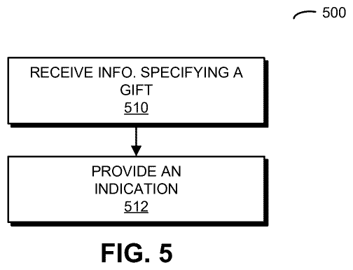

FIG. 5 presents a flow diagram illustrating an example of a method 500 for providing an indication of a gift for a recipient, which may be performed by a computer system (such as computer system 120 in FIG. 1). During operation, the computer system may receive information specifying the gift (operation 510) for the recipient. Then, when a physical address of the recipient is unknown, the computer system may provide, addressed to an electronic device, the indication (operation 512), where the indication includes an image of the gift.

In some embodiments, the receiving of the information (operation 510) may involve: receiving recipient information, including demographic data, a relationship with a giver of the gift, and/or one or more interests of the recipient; determining a list of one or more potential gifts for the recipient; and receiving a selection of the gift from the one or more potential gifts.

Note that the indication may include a virtual representation of the gift and/or a virtual gift card. The virtual gift card may include visual elements and a personalized message and may provide an interactive experience for the recipient. For example, the visual elements may include: a closed gift box, the image of the gift, confetti, and/or a message or gift card. Moreover, the indication may include a cost of the gift (which may include a price of the gift, taxes, and/or shipping costs).

Furthermore, the indication may include instructions for a recipient to use a monetary value associated with the gift. The instructions may guide the recipient on how to purchase the gift or, when the gift is not purchased, how to retain the monetary value.

Additionally, the indication may be provided using text or email.

In some embodiments of method 500, there may be additional or fewer operations. Moreover, the order of the operations may be changed, and/or two or more operations may be combined into a single operation.

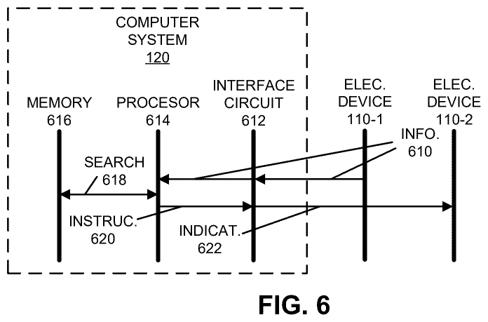

Embodiments of the gift delivery techniques are further illustrated in FIG. 6, which presents a drawing illustrating an example of communication among components in computer system 120. Notably, electronic device 110-1 (associated with a gift giver) may provide (e.g., in one or more packets or frames) information 610 specifying a gift for a recipient.

After receiving information 610, an interface circuit 612 in computer system 120 may provide information 610 to a processor 614 in computer system 120. Then, when a physical or postal address of the recipient is unknown (e.g., based at least in part on a search 618 of memory 616 in computer system 120), processor 614 may instruct 620 interface circuit 612 to provide an indication 622 to electronic device 110-2 (associated with a recipient), where indication 622 includes an image of the gift.

While FIG. 6 illustrates communication between components using unidirectional or bidirectional communication with lines having single arrows or double arrows, in general the communication in a given operation in this figure may involve unidirectional or bidirectional communication. Moreover, while operations are presented sequentially in FIG. 6, in general at least some of the operations may be performed concurrently or in parallel.

We now further describe the gift delivery techniques. In the gift delivery techniques, a gift may be delivered virtually. The gift may be selected from a set of one or more potential gifts based at least in part on recipient information, such as: demographic data (e.g., the recipient's age and/or gender), a relationship with the giver, and/or interests of the recipient (such as one or more hobbies). Notably, the computer system may assist the giver by suggesting potential gifts that align with the recipient's preferences and characteristics. In some embodiments, the giver may be prompted to answer questions regarding the recipient, which may further refine the gift suggestions provided by the computer system.

The giver may select a suitable gift from a list of potential gifts. This process may involve correlating the recipient's information with available gift options to ensure that the recommendations are appropriate. The computer system may ensure that the virtual gift card generated reflects the recipient's preferences, thereby increasing the likelihood of a positive reception.

Moreover, the computer system may create or generate an indication corresponding to the gift. The indication may include a virtual gift card with a visual representation of a selected gift from a list of potential gifts. This may include computing the price of the item, taxes, and shipping costs, thereby providing a comprehensive cost overview. The virtual gift card may be enhanced with interactive elements, such as a closed gift box that, when virtually opened, reveals the image of the gift, accompanied by confetti and/or a greeting card. Additionally, the indication may include instructions for a recipient to use a monetary value associated with the gift. Notably, the instructions may guide the recipient on how to purchase the gift or, when the gift is not purchased, how to retain the monetary value. Thus the indication may provide flexibility in how the recipient may choose to use the gift card. The computer system may ensure that the indication with the virtual gift card is delivered to the recipient via electronic communication (such as a text message or email) without requiring a physical delivery address. This process may facilitate the seamless sending of virtual gifts, allowing the giver to send a gift without needing detailed recipient information. The gift delivery techniques may ensure that the virtual gift card is both visually appealing and functionally comprehensive, enhancing the recipient's experience.

The computer system may transmit the indication with the virtual gift card to one or more recipients through electronic communication (such as text messages or emails) to ensure the delivery of the virtual gift card to the intended one or more recipient. This may also ensure that the recipient receives the gift in a timely and efficient manner. The communication may also handle the delivery of an interactive virtual gift experiences, which may include visual elements such as a closed gift box, an image of the selected gift, confetti, and/or a greeting card. These capabilities may enhance the recipient's experience by providing a visually engaging and interactive way to receive the virtual gift.

In some embodiments, the computer system may receive recipient information, which may include: demographic data, a relationship with a giver, and/or interests of the recipient. This information may be used to generate a list of potential gifts. The computer system may assist the giver in selecting an appropriate gift from the list of potential gifts. The giver may choose a suitable gift by asking questions about the recipient, such as: their age, gender, relationship with the user, and/or known hobbies. The computer system may make recommendations of potential gifts based at least in part on this gathered information. Moreover, the computer system may create a virtual gift card that includes a visual representation of the selected gift from the list of potential gifts and/or a total cost including any additional fees. This visual representation may include: an image of the gift, the price of the item, taxes, and/or a general shipping cost. Then, the computer system may send the virtual gift card to the recipient via electronic communication, which may include a text message or an email. The recipient may receive a message to withdraw funds to purchase the gift or to instructions to use the monetary value associated with the virtual gift card. The recipient may virtually open the gift to see an image of the gift, confetti, and/or a greeting card. Once again, the computer system may allow the recipient to either purchase the gift or retain the funds, guiding the recipient on gift card usage.

Furthermore, the computer system may be used to create a virtual gift card that includes a visual representation of a selected gift from a list of potential gifts. This operation may involve generating an image of the gift as a virtual gift card, which may include the price of the item, taxes, and a general shipping cost. The virtual gift card may serve as a visual representation of the gift with pricing details. The computer system may incorporate a virtual gift card generator to facilitate this process. The virtual gift card may be designed to include an interactive virtual gift experience, which may feature visual elements such as a closed gift box, an image of the selected gift, confetti, and/or a greeting card. The virtual gift card generator may provide instructions for using a monetary value associated with the virtual gift card. These instructions may guide the recipient on how to either purchase the selected gift or retain the funds. Additionally, the recipient may receive a message to withdraw funds to purchase the gift or to keep the money. Once again, this process may ensure the delivery of the virtual gift to the recipient without requiring a physical delivery address. The gift delivery techniques may facilitate the transmission of the virtual gift card, allowing the recipient to virtually open the gift and experience the interactive elements. This virtual opening may involve seeing a closed gift box, which, when clicked, may reveal the image of the gift, accompanied by confetti and/or a greeting card. The computer system may be designed to provide a seamless and engaging virtual gift-giving experience, leveraging the capabilities of the virtual gift card generator.

In the gift delivery techniques, the computer system may receive recipient information, which may include: demographic data, a relationship with a giver, and/or one or more interests of the recipient. This information may be gathered to facilitate the generation of a list of potential gifts that are appropriate for the recipient. The computer system may use the recipient's age, gender, relationship with the user, and/or one or more known hobbies to make these recommendations. The computer system may assist the giver in selecting an appropriate gift from the list of potential gifts by asking questions about the recipient. Alternatively, the computer system may use stored predefined preferences for the recipient. Thus, the computer system may generate gift options and assist in gift selection. The computer system may also gather recipient information to suggest appropriate gifts for the recipient.

Then, the computer system may generate a list of potential gifts based at least in part on the recipient information. This process may involve the computer system receiving recipient information, which can include: demographic data, a relationship with a giver, and/or one or more interests of the recipient. The computer system may use this information to generate a list of potential gifts that align with the recipient's preferences and characteristics. The computer system may also assist the giver in selecting an appropriate gift from the list of potential gifts, ensuring that the chosen gift is suitable for the recipient. The computer system may ask questions about the recipient (such as their age, gender, relationship with the user, and/or one or more known hobbies) to gather the necessary information for generating gift recommendations. This process may involve making recommendations of potential gifts that are appropriate or suitable for the recipient based at least in part on the gathered information. The computer system or the user may choose a suitable gift from the list of potential gifts, which may then be used to create a virtual gift card. The virtual gift card may include a visual representation of the selected gift, along with pricing details (such as the price of the item, taxes, and shipping cost).

Moreover, the computer system may select or create a virtual gift card that includes a visual representation of a selected gift from a list of potential gifts. This virtual gift card may also encompass a total cost, which can include any additional fees such as taxes and shipping costs. The virtual gift card may include an interactive virtual gift experience, which can include visual elements and a personalized message. These visual elements may include a closed gift box, an image of the selected gift, confetti, and/or a greeting card. The creation of the virtual gift card may involve generating an image of the gift as a virtual gift card, which may serve to provide a visual representation of the gift along with pricing details. This process may be facilitated by a virtual gift card generator, which may generate the visual representation of the selected gift and the total cost based at least in part on pricing details, such as: the price of the selected gift, taxes, and/or a shipping cost. The virtual gift card generator may also be responsible for incorporating the interactive virtual gift experience, which may enhance the recipient's engagement with the virtual gift.

Next, the computer system may send the virtual gift card to the recipient through electronic communication. This process may involve the computer system selecting an appropriate communication technique (such as a text message or an email). This may ensure that the virtual gift card is transmitted to the recipient without requiring a physical delivery address.

Furthermore, the virtual gift card generator may provide the recipient with instructions for using the monetary value associated with the virtual gift card. This may involve the recipient receiving a message that outlines the options available for the monetary value. The recipient may have the option to either purchase the selected gift (e.g., via the computer system) or retain the monetary value for other uses. The virtual gift card generator may facilitate this by generating a message that guides the recipient on how to proceed with these options. The instructions may be designed to ensure that the recipient understands how to access and use the funds associated with the virtual gift card.

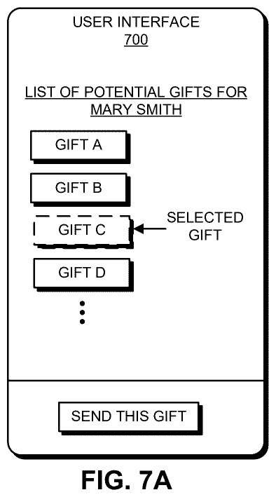

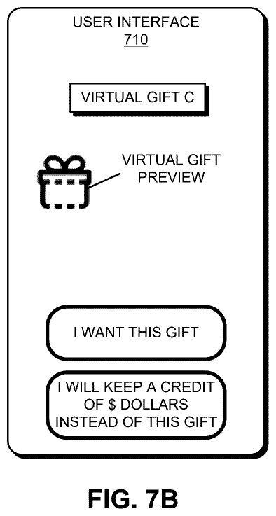

FIGS. 7A and 7B present drawings illustrating examples of user interfaces. Notably, FIG. 7A presents a user interface 700 with a list of potential gifts and a user-selection of one of the potential gifts. Moreover, FIG. 7B presents a user interface 710 with an indication corresponding to a virtual gift.

In some embodiments, the computer system in the gift delivery techniques may be integrated with an online store via one or more APIs. A web page or website of the online store may display a gift purchase button for each product or set of products, and a user interface may allow a user to select and store a specific gift item using the gift purchase button. A gift creation process may be accessible when a user selects the gift purchase button, with a set of instructions guiding the user through the process and gathering required gift details. Moreover, a payment processing module may allow the user to complete the payment for the gift without specifying the exact size or variation of the gift item. Thus, in some embodiments, the size may not be specified when the gift is given. Instead, the size may be provided subsequently by the recipient. Furthermore, a virtual gift creation module may create a digital preview of the physical gift item (or a virtual gift) and a link generation module may generate a link to the virtual gift. Additionally, a sharing module may enable the user to share the virtual gift link with the gift recipient.

Some examples of the virtual gift may include a digital wrapping that can be unwrapped to reveal the contents, providing a digital representation of the physical gift item.

The computer system may include an access module that allows the gift recipient to access the virtual gift through the shared link. Moreover, an options module may present the gift recipient with options to: pick up the physical gift item at a selected store, have it shipped to a specified address, accept the gift item directly, choose specific variations, exchange it for another available item of the same or higher price, and/or receive a gift voucher to be spent in-store or online at the discretion of the store.

Note that specific variations of the gift item may include: size, color, dimension, quantity, and version.

Furthermore, the options module may allow the gift recipient to pick up the physical gift item at a selected store by providing a gift code, barcode, and/or QR code for pickup. Moreover, the options module may allow the gift recipient to have the physical gift item shipped to a specified address by displaying fields for the recipient to fill out the shipping information and confirm the shipping request.

The computer system may include a scheduling module that allows the user to schedule automatic sending of the virtual gift link to the gift recipient at a specified date and time via email or text message. A delivery module may send the virtual gift link to the gift recipient at the specified date and time, and a notification module may send a notification to the user confirming the delivery of the virtual gift link to the gift recipient.

In these embodiments, the process may involve the display of a gift purchase button on the online store's website for each product or set of products. This operation may be facilitated by the integration of a gift selection and delivery system with the online store through APIs. The gift purchase button may serve as an interface element that allows a user to initiate the gift creation process. The presence of this button on the web page or website may enable users to engage with the gift selection system seamlessly. The integration of the gift selection and delivery system with the online store may be achieved through APIs, which may allow for the dynamic display of the gift purchase button for each product or set of products available on the store's web page or website. This integration may ensure that the button is consistently available, providing users with the opportunity to select and send gifts directly from the online store. The display of the gift purchase button may be an operation in the overall process, as it may act as the entry point for users to access the gift creation flow and follow the instructions for selecting and sending gifts. This functionality may be supported by the underlying system, which may manage the integration and ensure that the button is displayed appropriately for each product or set of products. This operation may be for enabling the user interaction necessary for the subsequent operations in the gift sending process, as it may provide the initial interface through which users may engage with the computer system and begin the process of selecting and sending gifts.

Note that the process may involve allowing a user to select a specific gift item and store it through the gift purchase button. This operation may be facilitated by a user interface that enables the user to interact with the web page or website of the online store. The user may be presented with options to choose a specific gift item, such as a dress, from a particular store, e.g., a clothing store. The selection process may be supported by an API that integrates with the online store, allowing interaction between the user and the inventory of the store. The user may not be required to specify the exact size or variation of the gift item at this stage, which may simplify the selection process in the case the giver doesn't know the specific color preference or specific size of the recipient etc. This approach may enhance the user experience by providing flexibility in gift selection and may potentially increase the likelihood of completing a purchase. The computer system may then proceed to the next operations, which may involve accessing the gift creation process and guiding the user through the necessary operations to finalize the gift transaction.

Then, the user may access the gift creation process upon selecting the gift purchase button. This process may involve the initiation of a gift creation flow, which can be guided by the instructions from the computer system. The computer system may provide a structured pathway for the user to follow, ensuring that the details for the gift creation are gathered efficiently. The gift creation flow may be designed to facilitate a transition from the selection of the gift purchase button to the subsequent operations in the gift creation process. This operations may serve as a juncture where the user is transitioned from browsing to actively engaging in the gift creation, setting the stage for further actions such as payment processing and digital gift creation. The instructions from the computer system may play a role in guiding the user through this process, ensuring that the user is informed and supported during the gift creation journey. This operations may bridge the gap between user selection and the realization of a virtual gift, thereby enhancing the user experience and ensuring the execution of the gift sending process. Note that the gathering of required gift details may include collecting information such as the recipient's name, contact information, and any personalized messages or preferences that the user wishes to include with the gift. This operations may ensure that the gift is tailored to the recipient's information (such as email or cell phone) and that the necessary information is captured to facilitate the subsequent operations in the gift sending process. The instructions from the computer system may be dynamically adjusted based on the user's inputs, providing an experience that aligns with the user's specific needs and the nature of the gift being created. This approach may help in minimizing errors and ensuring that the gift creation process is completed accurately and efficiently. The computer system may include an access module that allows the gift recipient to access the virtual gift through a shared link. Moreover, an options module may present the gift recipient with options to pick up the physical gift item at a selected store, have it shipped to a specified address, accept the gift item directly, choose specific variations, exchange it for another available item of the same or higher price, and/or receive a gift voucher to be spent in-store or online at the store

We now describe embodiments of an electronic device. FIG. 8 presents a block diagram illustrating an example of an electronic device 800, such as one of electronic devices 110, optional base station 114, optional access point 118 and/or computer system 120 in FIG. 1. This electronic device includes processing subsystem 810, memory subsystem 812, and networking subsystem 814. Processing subsystem 810 includes one or more devices configured to perform computational operations. For example, processing subsystem 810 can include one or more microprocessors, one or more GPUs, one or more application-specific integrated circuits (ASICs), one or more microcontrollers, one or more programmable-logic devices, and/or one or more digital signal processors (DSPs).

Memory subsystem 812 includes one or more devices for storing data and/or instructions for processing subsystem 810 and networking subsystem 814. For example, memory subsystem 812 can include dynamic random access memory (DRAM), static random access memory (SRAM), and/or other types of memory. In some embodiments, instructions for processing subsystem 810 in memory subsystem 812 include: one or more program modules or sets of instructions (such as program module 822 or operating system 824), which may be executed by processing subsystem 810. Note that the one or more computer programs may constitute a computer-program mechanism. Moreover, instructions in the various modules in memory subsystem 812 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 810.

In addition, memory subsystem 812 can include mechanisms for controlling access to the memory. In some embodiments, memory subsystem 812 includes a memory hierarchy that comprises one or more caches coupled to a memory in electronic device 800. In some of these embodiments, one or more of the caches is located in processing subsystem 810.

In some embodiments, memory subsystem 812 is coupled to one or more high-capacity mass-storage devices (not shown). For example, memory subsystem 812 can be coupled to a magnetic or optical drive, a solid-state drive, or another type of mass-storage device. In these embodiments, memory subsystem 812 can be used by electronic device 800 as fast-access storage for often-used data, while the mass-storage device is used to store less frequently used data.

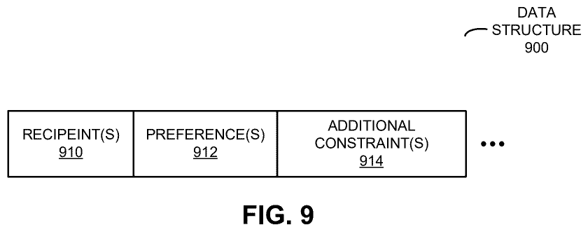

Memory subsystem 812 may store information associated with predefined preferences of one or more recipients. This is shown in FIG. 9, which presents an example of a data structure 900. Notably, data structure 900 may include information specifying: one or more recipients 910, one or more predefined preferences 912 of the one or more recipients 910, and one or more additional constraints 914.

Referring back to FIG. 8, networking subsystem 814 includes one or more devices configured to couple to and communicate on a wired and/or wireless network (i.e., to perform network operations), including: control logic 816, an interface circuit 818, one or more antennas 820 and/or input/output (I/O) port 830. (While FIG. 8 includes one or more antennas 820, in some embodiments electronic device 800 includes one or more nodes 808, e.g., a pad, which can be coupled to one or more antennas 820. Thus, electronic device 800 may or may not include one or more antennas 820.) For example, networking subsystem 814 can include a Bluetooth networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi networking system), an Ethernet networking system, and/or another networking system.

Networking subsystem 814 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 800 may use the mechanisms in networking subsystem 814 for performing simple wireless communication between the electronic devices, e.g., transmitting advertising or beacon frames and/or scanning for advertising frames transmitted by other electronic devices as described previously.

Within electronic device 800, processing subsystem 810, memory subsystem 812, and networking subsystem 814 are coupled together using bus 828. Bus 828 may include an electrical, optical, and/or electro-optical connection that the subsystems can use to communicate commands and data among one another. Although only one bus 828 is shown for clarity, different embodiments can include a different number or configuration of electrical, optical, and/or electro-optical connections among the subsystems.

In some embodiments, electronic device 800 includes a display subsystem 826 for displaying information on a display, which may include a display driver and the display, such as a liquid-crystal display, a multi-touch touchscreen, etc. Moreover, electronic device 800 may optionally include a user-interface subsystem 832 for receiving or providing information about a potential gift.

Electronic device 800 can be (or can be included in) any electronic device with at least one network interface. For example, electronic device 800 can be (or can be included in): a desktop computer, a laptop computer, a subnotebook/netbook, a server, a tablet computer, a smartphone, a cellular telephone, a smartwatch, a consumer-electronic device, a portable computing device, an access point, a router, a switch, communication equipment, test equipment, a security camera, an aviation drone, a camera, a wearable appliance, and/or another electronic device.

Although specific components are used to describe electronic device 800, in alternative embodiments, different components and/or subsystems may be present in electronic device 800. For example, electronic device 800 may include one or more additional processing subsystems, memory subsystems, networking subsystems, display subsystems and/or audio subsystems. Additionally, one or more of the subsystems may not be present in electronic device 800. Moreover, in some embodiments, electronic device 800 may include one or more additional subsystems that are not shown in FIG. 8. Also, although separate subsystems are shown in FIG. 8, in some embodiments, some or all of a given subsystem or component can be integrated into one or more of the other subsystems or component(s) in electronic device 800. For example, in some embodiments program module 822 is included in operating system 824.

Moreover, the circuits and components in electronic device 800 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 814, such as a radio. Moreover, the integrated circuit may include hardware and/or software mechanisms that are used for transmitting wireless signals from electronic device 800 and receiving signals at electronic device 800 from other electronic devices. Aside from the mechanisms herein described, radios are generally known in the art and hence are not described in detail. In general, networking subsystem 814 and/or the integrated circuit can include any number of radios. Note that the radios in multiple-radio embodiments function in a similar way to the described single-radio embodiments.

In some embodiments, networking subsystem 814 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, receiving the input data, etc.)

While communication protocols compatible with Ethernet and Wi-Fi were used as illustrative examples, the described embodiments of the evaluation and/or gift delivery techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the evaluation and/or gift delivery techniques may be implemented using program module 822, operating system 824 (such as a driver for interface circuit 818) and/or in firmware in interface circuit 818. Alternatively or additionally, at least some of the operations in the evaluation and/or gift delivery techniques may be implemented in a physical layer, such as hardware in interface circuit 818.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

In the preceding description, we refer to ‘some embodiments.’ Note that ‘some embodiments’ describes a subset of all of the possible embodiments, but does not always specify the same subset of embodiments.

Moreover, note that the numerical values provided are intended as illustrations of the evaluation and/or gift delivery techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with an electronic device;
a processor configured to execute program instructions; and
memory storing the program instructions, wherein, when the processor executes the program instructions, the computer system performs operations comprising:
receiving, using the interface circuit and from the electronic device, information specifying the potential gift for a recipient and second information specifying the recipient;
accessing, in the memory, predefined preferences associated with the recipient;
determining suitability of the potential gift for the recipient based at least in part on the predefined preferences;
when the potential gift is unsuitable, providing, addressed to the electronic device, a recommendation for a suitable alternative gift for the recipient based at least in part on the predefined preferences; and
when the potential gift is suitable, providing, addressed to the electronic device, a confirmation to proceed with the gift.

2. The computer system of claim 1, wherein the predefined preferences comprise abstracted information that is different from a specific product, a type of product, or wish list or a registry of gifts.

3. The computer system of claim 2, wherein the predefined preferences comprise: one or more characteristics of the specific product or the type of product, a preference of the recipient, or a medical constraint of the recipient.

4. The computer system of claim 1, wherein the suitability is determined based on a comparison of a weighted summation of numerical values for the predefined preferences for the potential gift with a predefined threshold.

5. The computer system of claim 1, wherein the suitability is determined using a pretrained neural network.

6. The computer system of claim 1, wherein the suitability is determined based at least in part on additional constraints; and
wherein the additional constraints comprise one or more of: dietary constraints of the recipient, a clothing size of the recipient, a favorite color of the recipient, a budget, a relationship between the recipient and a planned purchaser of the potential gift, a gifting occasion, an age of the recipient, or a physical location.

7. The computer system of claim 1, wherein the electronic device is associated with a planned purchaser of the potential gift.

8. The computer system of claim 1, wherein the predefined preferences were voluntarily defined or provided by the recipient.

9. The computer system of claim 1, wherein the recipient previously provided the preference.

10. The computer system of claim 1, wherein, when the potential gift is suitable, the operations comprise purchasing the potential gift for the recipient.

11. The computer system of claim 1, wherein, when the predefined preferences do not exist or are unavailable, the operations comprise providing an invitation to the recipient to create preferences.

12. A non-transitory computer-readable storage medium for use in conjunction with a computer system, the computer-readable storage medium storing program instructions that, when executed by the computer system, cause the computer system to perform operations comprising:
receiving, from an electronic device, information specifying the potential gift for a recipient and second information specifying the recipient;
accessing, in the memory, predefined preferences associated with the recipient;
determining suitability of the potential gift for the recipient based at least in part on the predefined preferences;
when the potential gift is unsuitable, providing, addressed to the electronic device, a recommendation for a suitable alternative gift for the recipient based at least in part on the predefined preferences; and
when the potential gift is suitable, providing, addressed to the electronic device, a confirmation to proceed with the gift.

13. The non-transitory computer-readable storage medium of claim 12, wherein the predefined preferences comprise abstracted information that is different from a specific product, a type of product, or wish list or a registry of gifts.

14. The non-transitory computer-readable storage medium of claim 13, wherein the predefined preferences comprise: one or more characteristics of the specific product or the type of product, a preference of the recipient, or a medical constraint of the recipient.

15. A method for evaluating a potential gift, comprising:
by a computer system:
receiving, from an electronic device, information specifying the potential gift for a recipient and second information specifying the recipient;
accessing, in the memory, predefined preferences associated with the recipient;
determining suitability of the potential gift for the recipient based at least in part on the predefined preferences;
when the potential gift is unsuitable, providing, addressed to the electronic device, a recommendation for a suitable alternative gift for the recipient based at least in part on the predefined preferences; and
when the potential gift is suitable, providing, addressed to the electronic device, a confirmation to proceed with the gift.

16. The method of claim 15, wherein the predefined preferences comprise abstracted information that is different from a specific product, a type of product, or wish list or a registry of gifts.

17. The method of claim 16, wherein the predefined preferences comprise: one or more characteristics of the specific product or the type of product, a preference of the recipient, or a medical constraint of the recipient.

18. The method of claim 15, wherein the suitability is determined based on a comparison of a weighted summation of numerical values for the predefined preferences for the potential gift with a predefined threshold.

19. The method of claim 15, wherein the suitability is determined using a pretrained neural network.

20. The method of claim 15, wherein the suitability is determined based at least in part on additional constraints; and
wherein the additional constraints comprise one or more of: dietary constraints of the recipient, a clothing size of the recipient, a favorite color of the recipient, a budget, a relationship between the recipient and a planned purchaser of the potential gift, a gifting occasion, an age of the recipient, or a physical location.
